(19) United States
(12) Patent Application Publication
(10) Pub. No.: US 2014/0015664 A1
(43) Pub. Date: Jan. 16, 2014

(54) Child car Seat Alarm System

(71) Applicant: Greg Watson, Coral Springs, FL (US)

(72) Inventor: Greg Watson, Coral Springs, FL (US)

(21) Appl. No.: 13/547,280

(22) Filed: Jul. 12, 2012

(51) Int. Cl. B60Q 11/00

(52) U.S. Cl. CPC B60Q 11/00
USPC 340/457.1

(57) ABSTRACT

A child car seat system that alarms a guardian of a child that the child has accidently been left in the child car seat. The system comprises of a child car seat that has seat belt that is wired to a transmitter, the seat belt has a first terminal and second terminal locking latch, when the first terminal and second terminal locking latches are latched to each other, a closed electrical loop is formed and a first signal is transmitted from the transmitter, when the first and second terminal locking latches are unlatched, a second signal is transmitted from the transmitter. The system further comprises of a receiver, the receiver defines at least one alarm that warns the user of the system that a child has been left in the child car seat, the receiver activates when it receives the first signal and deactivated when it receives the second signal, the receiver has a sensor that will activate the alarm if the receiver is moved a certain distance away from transmitter when the receiver is activated. The receiver can be a key fob.

### BACKGROUND

The present invention is directed to a child car seat alarm system that only activates when the belt buckle of a child car seat is buckled, that does not depend on the automobile for monitoring, that does not depend on weight sensors, that does not require car doors to be closed, that does not require ignition switches to be turned on, and/or mirrors to be adjusted. The child car seat is one hundred percent wireless and it does not require the user to install any parts after the purchasing of the car seat.

The scope of the present invention is to provide a child car seat alarm system that will warn a guardian of a child using the child car seat that they have left their child in a car. The child car seat can be used on any car, for it is a system that only depends on the child car seat and a receiver or key fob that will be carried by the guardian. It is foreseen that the child car seat can also be used on strollers or child carriers.

There are other child warning devices that are used to warn a guardian that they are leaving their child in a car-seat: See Kalce, U.S. Pat. No. 6,998,988; and Sweeney, U.S. U.S. Patent publication number 2007/0222622, they are discussed below.

Kalce, U.S. Pat. No. 6,998,988 discloses an infant alarm system for automobiles that sets of an alarm when the driver seat is unoccupied; the system has a pressure sensor pad for detecting the presence of a person in a car seat. The system also uses a belt buckle switch that determines whether a belt buckle is buckled to an infant car seat. The system also has a control box that is electrically connected to the pressure sensor pad and the belt buckle switch. The control box is for outputting an alarm signal when the belt buckle switch indicates that the belt buckle is buckled into the infant car seat and the pressure sensor pad does not detect the presence of the person in the car seat. The present invention is not analogous to Kalce, for it is a simple device that only depends on the child car seat belt buckle being buckled and a receiver that will trigger an alarm when the receiver is a certain distance from the child car seat.

Sweeney U.S. Patent publication number 20070222622 discloses a system for alerting someone that a child is in a safety seat in a vehicle includes a proximity sensor/transmitter and a receiver. The receiver is removably mounted on a child's car seat and the proximity sensor/transmitter remains on the car seat. After a child is placed in the seat, the receiver is removed from the seat and placed on the driver or other adult responsible for the child. The receiver can be placed in the person's purse or on their person. If the person moves away from the vehicle without disabling the transmitter on the car seat will activate that receiver as soon as the receiver has moved a prescribed distance away from the vehicle. The receiver will generate a signal, such as an audible and/or visible signal, which will attract the attention of the person carrying the receiver. The signal will be generated in a continuous manner until the transmitter is disabled, which can only be done after the child is removed from the seat. The present invention is directed to a child car seat alarm system that is only armed by the child car seat belt buckle being buckled and disarmed by the child car seat belt buckle being unbuckled. The belt buckle creates a closed loop that activates a transmitter that is fixedly attached to the child car seat. The transmitter when activated sends a signal to a receiver or key fob. The receiver or key fob turns on when it receives the signal. The receiver or key fob is set to alarm a user carrying the receiver or key fob if the receiver or key fob is not turned off and the receiver or key fob senses that it is not within a preset distance from the transmitter. The receiver or key fob can only be turned off by unbuckling the child car seat buckle, thereby preventing a malfunction with the system; the child car seat must be unbuckled for the transmitter to send the signal disarming the receiver or key fob.

The present invention is a simple analogue or digital device that ensures that a guardian must unbuckle a child prior to walking a certain distance away from a vehicle. The present invention is an example of an analog or digital electronic device that operates through the engineering of the electrical components in the child car seat and in the warning device, leading to long-term reliability and affordability for everyone.

For the forgoing reasons there is a need of a child car seat system that will warn a guardian of a child that a child has been left in the child car seat that is simple to manufacture and does not require the end user to install components into their vehicle.

### SUMMARY

The present invention is a child car seat system for warning a guardian of a child that the child has been left in a child seat, the system comprises of a child car-seat that has seat belt that is wired to a transmitter, the seat belt has a first terminal and second terminal locking latch, when the first terminal and second terminal locking latches are latched to each other, a closed electrical loop is formed and a first signal is transmitted from the transmitter, when the first and second terminal locking latches are unlatched, a second signal is transmitted from the transmitter. The system further comprises of a receiver or key fob, the receiver or key fob defines at least one alarm that warns the user of the system that a child has been left in the child car seat, the receiver or key fob activates when it receives the first signal and deactivated when it receives the second signal, the receiver or key fob has a sensor that will activate the alarm if the receiver or key fob is moved a certain distance away from transmitter when the receiver or key fob is activated. The present invention's transmitter and receiver or key fob connect wirelessly and do not depend on the child car seat being connected to the vehicle in which it is used.

An object of the present invention is to provide a warning device that will prevent a child from being accidently left in an automobiles.

Another object of the present invention is to provide a device that will be economical to manufacture and easy to implement.

### DRAWINGS

These and other features, aspects and advantage of the present invention will become better understood with regard to the following description, appended claims and drawings where:

FIG. 1 is a perspective view of the receiver of the present invention; and

FIG. 2 is a perspective view of the child car seat system showing the loop that activates the transmitter.

### DESCRIPTION

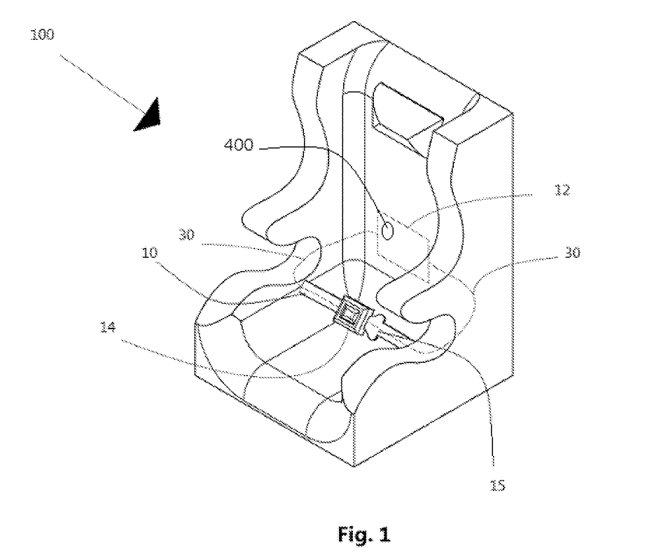

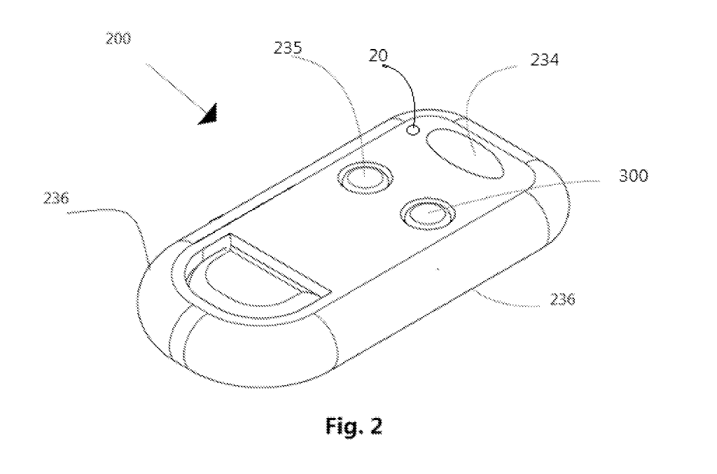

As seen in FIGS. 1-2 a child car seat system for warning a guardian of a child that the child has been left in a child seat, the system comprises of a child car-seat 100 that has seat belt 10 that is wired to a transmitter 12, the seat belt has a first terminal 14 and second terminal 15 locking latch, when the first terminal 14 and second terminal 15 locking latches are latched to each other, a closed electrical loop 30 is formed and a first signal is transmitted from the transmitter 12, when the first 14 and second terminal 15 locking latches are unlatched, a second signal is transmitted from the transmitter 12; and a receiver 200, the receiver 200 defines at least one alarm 234, 235, 236 that warns the user of the system that a child has been left in the child car seat 100, the receiver 200 activates when it receives the first signal and deactivated when it receives the second signal, the receiver 200 has a sensor 20 that will activate the alarm 234, 235, 236 if the receiver 200 is moved a certain distance away from transmitter 12 when the receiver 200 is activated. The receiver 200 may be a key fob.

The transmitter 200 defines an internal safety device 400 that sounds an alarm when the transmitter's power is low.

In another embodiment of the present invention, the receiver's 200 alarm may be a speaker 234 that emits a loud noise or a light source 235 that lights when activated.

In a further embodiment of the present invention, the alarm 234, 235, 236 may be a vibrator that vibrates 236 when activated. In a preferred embodiment, all of the alarms will activate simultaneously.

In still a further embodiment, the receiver defines a recessed off button 300 that turns the alarms off in case of a malfunction.

An advantage of the present invention is that it provides a warning device that prevents a child from being accidently left in an automobiles.

Another advantage of the present invention is that it provides a device that is economical to manufacture and easy to implement.

Although the present invention has been described in considerable detail in reference to preferred versions, other versions are possible. Therefore, the spirit and scope of the appended claims should not be limited to the description of the preferred versions contained herein.

What is claimed is:

1. A child car seat alarm system for warning a guardian of a child that a child has been left in a child car seat, the system comprises of:
A child car seat that has seat belt that is wired to a transmitter, the seat belt has a first terminal and second terminal locking latch, when the first terminal and second terminal locking latches are latched to each other, a closed electrical loop is formed and a first signal is transmitted from the transmitter, when the first and second terminal locking latches are unlatched, a second signal is transmitted from the transmitter; and
a receiver, the receiver defines at least one alarm that warns the user of the system that a child has been left in the child car seat, the receiver activates when it receives the first signal and deactivated when it receives the second signal, the receiver has a sensor that will activate the alarm if the receiver is moved a certain distance away from transmitter when the receiver is activated.

2. The child car seat of claim 1, wherein the transmitter defines an internal safety device that emits a noise if the transmitter's power is low.

3. The child car seat of claim 1, wherein the receiver's alarm comprises of a light source, a speaker, and a vibrator that all activate simultaneously.

4. The child car seat of claim 1, wherein the receiver defines a recessed off button that turns the receiver off if there is a malfunction with the system.

5. The child car seat of claim 1, wherein the receiver is a key fob.
